(19) United States
(12) Patent Application Publication
(10) Pub. No.: US 2026/0289400 A1
(43) Pub. Date: Sep. 24, 2026

(54) METHOD FOR SECURELY DEPLOYING A MODEL, DEVICE AND STORAGE MEDIUM

(71) Applicant: Beijing Volcano Engine Technology Co., Ltd., Beijing (CN)

(72) Inventors: Bofeng WU, Beijing (CN); Xuhao ZHANG, Beijing (CN)

(21) Appl. No.: 19/416,649

(22) Filed: Dec. 11, 2025

(30) Foreign Application Priority Data
Mar. 18, 2025 (CN) 202510323484.1

(51) Int. Cl. G06N 20/00; H04L 9/08

(52) U.S. Cl. CPC G06N 20/00; H04L 9/0819; H04L 9/0894

(57) ABSTRACT

A method for securely deploying a model, a device, and a storage medium are provided. The method includes: receiving, from a user side, a deployment request for a machine learning model, the deployment request including at least a model identification of the machine learning model that is encrypted and a key identification of a key used to encrypt the machine learning model; obtaining the machine learning model that is encrypted and the key based on the deployment request; decrypting, in a trusted execution environment, the machine learning model that is encrypted using the key to obtain the machine learning model; and deploying the machine learning model in the trusted execution environment.

### CROSS-REFERENCE TO RELATED APPLICATION

The present application claims priority to the Chinese Patent Application No. 202510323484.1, filed on Mar. 18, 2025, the disclosure of which is incorporated herein by reference in its entirety as part of the present application.

### TECHNICAL FIELD

Embodiments of the present disclosure relate to a method for securely deploying a model, a device, and a storage medium.

### BACKGROUND

With the rapid development of big data and cloud computing technologies, more and more cloud tenants deploy and store data (such as machine learning models of users) on cloud environments to improve production efficiency and decision-making capabilities. How to improve data security on cloud environments has become an urgent issue that needs attention. In particular, in the process of data interaction between a user side and a cloud side, how to ensure the security of a model deployed in a cloud environment has become a problem that needs to be solved urgently.

### SUMMARY

In the present disclosure, a method for securely deploying a model is provided. The method includes: receiving, from a user side, a deployment request for a machine learning model, the deployment request including at least a model identification of the machine learning model that is encrypted and a key identification of a key used to encrypt the machine learning model; obtaining the machine learning model that is encrypted and the key based on the deployment request; decrypting, in a trusted execution environment, the machine learning model that is encrypted using the key to obtain the machine learning model; and deploying the machine learning model in the trusted execution environment.

In the present disclosure, a method for securely deploying a model is provided. The method includes: encrypting, using a key, a machine learning model to be deployed to obtain an encrypted machine learning model; storing the encrypted machine learning model to determine a model identification of the encrypted machine learning model; and sending a deployment request to a container service, the deployment request including at least the model identification and a key identification of the key.

In the present disclosure, an apparatus for securely deploying a model is provided. The apparatus includes: a receiving module, configured to receive, from a user side, a deployment request for a machine learning model, the deployment request including at least a model identification of the machine learning model that is encrypted and a key identification of a key used to encrypt the machine learning model; an obtaining module, configured to obtain the machine learning model that is encrypted and the key based on the deployment request; a decryption module, configured to decrypt, in a trusted execution environment, the machine learning model that is encrypted using the key to obtain the machine learning model; and a deployment module, configured to deploy the machine learning model in the trusted execution environment.

In the present disclosure, an apparatus for securely deploying a model is provided. The apparatus includes: an encryption module, configured to encrypt, using a key, a machine learning model to be deployed to obtain an encrypted machine learning model; a storage module, configured to store the encrypted machine learning model to determine a model identification of the encrypted machine learning model; and a sending module, configured to send a deployment request to a container service, the deployment request including at least the model identification and a key identification of the key.

In the present disclosure, an electronic device is provided. The device includes at least one processor; and at least one memory, coupled to the at least one processor and storing instructions executable by the at least one processor, where the instructions, when executed by the at least one processor, cause the device to perform the method according to at least one embodiment of the present disclosure.

In the present disclosure, a computer-readable storage medium is provided. The computer-readable storage medium stores a computer program, where the computer program is executable by a processor to implement the method according to at least one embodiment of the present disclosure.

In the present disclosure, a computer program product is provided. The product includes computer executable instructions, where the computer executable instructions, when executed by a processor, implement the method according to at least one embodiment of the present disclosure.

It should be understood that the content described in this section is neither intended to identify key or essential features of the implementations of the present disclosure, nor is it intended to limit the scope of the present disclosure. Other features of the present disclosure will be readily envisaged through the following description.

### BRIEF DESCRIPTION OF DRAWINGS

The foregoing and other features, advantages, and aspects of the implementations of the present disclosure become more apparent with reference to the following detailed description and in conjunction with the drawings. In the drawings, the same or similar reference numerals denote the same or similar elements.

FIG. 1A is a schematic diagram of an example interaction process of model deployment;

FIG. 1B is a schematic diagram of an example environment in which the implementations of the present disclosure may be implemented;

FIG. 2 is a schematic diagram of an example interaction process of securely deploying a model according to some embodiments of the present disclosure;

FIG. 3 is a schematic diagram of an example interaction scenario of securely deploying a model according to some embodiments of the present disclosure;

FIG. 4 is a flowchart of a process of securely deploying a model applied to a container service according to some embodiments of the present disclosure;

FIG. 5 is a flowchart of a process of securely deploying a model applied to a user-side device according to some embodiments of the present disclosure;

FIG. 6 is a block diagram of an apparatus for securely deploying a model applied to a container service according to some embodiments of the present disclosure;

FIG. 7 is a block diagram of an apparatus for securely deploying a model applied to a user-side device according to some embodiments of the present disclosure; and

FIG. 8 is a block diagram of a device capable of implementing a plurality of embodiments of the present disclosure.

### DETAILED DESCRIPTION

The implementations of the present disclosure are described in more detail below with reference to the drawings. Although some implementations of the present disclosure are shown in the drawings, it should be understood that the present disclosure may be implemented in various forms and should not be construed as being limited to the implementations set forth herein. On the contrary, these implementations are provided for a more thorough and complete understanding of the present disclosure. It should be understood that the drawings and the implementations of the present disclosure are only for illustrative purposes, and are not intended to limit the protection scope of the present disclosure.

In the description of the implementations of the present disclosure, the term "include/comprise" and similar terms thereof should be understood as open-ended inclusions, that is, "include/comprise but not limited to". The term "based on" should be understood as "at least partially based on". The term "an implementation" or "the implementation" should be understood as "at least one implementation". The term "some implementations" should be understood as "at least some implementations". The following may also include other explicit and implicit definitions.

In this specification, unless explicitly stated, performing a step "in response to A" does not mean that the step is performed immediately after "A", and one or more intermediate steps may be included.

It may be understood that the data involved in the technical solution (including but not limited to the data itself, acquisition, use, storage, or deletion of the data) should comply with requirements of corresponding laws, regulations, and related provisions.

It may be understood that before the use of the technical solution disclosed in the implementations of the present disclosure, the type, scope of use, use scenarios, etc., of information involved in the present disclosure should be informed to a related user and the authorization of the related user should be obtained through an appropriate manner in accordance with related laws and regulations, where the related user may include any type of subject of rights, such as an individual, an enterprise, or a group.

For example, in response to reception of an active request from a user, prompt information is sent to the related user to clearly inform the related user that the requested operation will require access to and use of information of the related user, so that the related user may independently choose, based on the prompt information, whether to provide the information to software or hardware, such as an electronic device, an application, a server, or a storage medium, that performs the operation of the technical solution of the present disclosure.

As an optional but non-restrictive implementation, in response to the reception of the active request from the related user, the prompt information may be sent to the related user in the form of, for example, a pop-up window, in which the prompt information may be presented in text. In addition, the pop-up window may also include a selection control for the user to select whether to "agree" or "disagree" to provide the information to the electronic device.

It may be understood that the above process of notifying and obtaining user authorization is only illustrative, and does not limit the implementations of the present disclosure. Other manners that satisfy the related laws and regulations may also be applied in the implementations of the present disclosure.

As briefly described above, a user may deploy a machine learning model to a cloud environment to use computing resources provided by the cloud environment to perform processes such as data inference. These machine learning models are often trained, debugged, or distilled by the user, and carry the proprietary knowledge and core business logic of the user, and thus have a high requirement for privacy protection and data security.

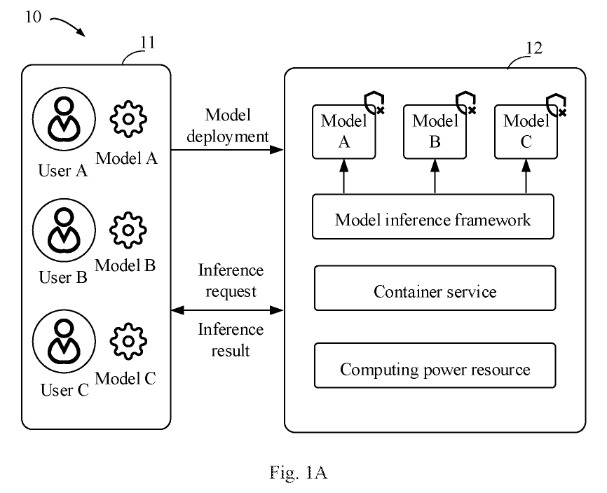

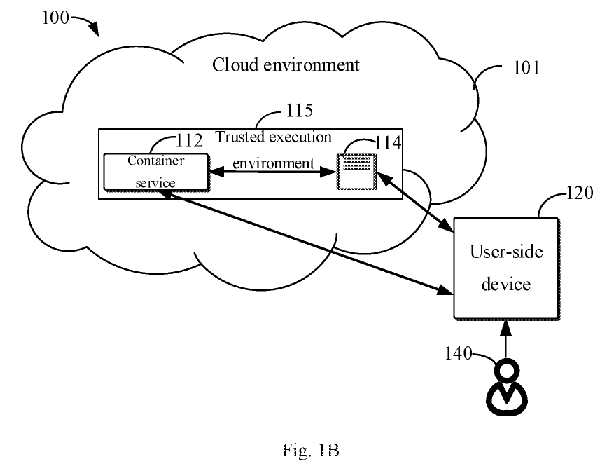

FIG. 1A is a schematic diagram of an example process 10 of model deployment. As shown in FIG. 1A, to better perform an inference task by using cloud computing power resources, a user side 11 (for example, users A, B, and C) may deploy their proprietary machine learning models (for example, models A, B, and C) to a public cloud platform 12.

Conventionally, a model management and inference platform (such as the cloud platform 12) provided by a cloud vendor usually requires the user side 11 to upload a plaintext data file of a model for model deployment. The machine learning models of the users are usually deployed on the cloud in plaintext. This means that a provider of the cloud platform 12 (for example, a background administrator or an operation and maintenance personnel of the cloud vendor) may theoretically access these machine learning models, for example, use model parameters to train its own model or provide the machine learning models to a third party without authorization. In the process of model inference, data input by the user side 11 and data output by the model may be viewed or obtained. In this process, there is a lack of an effective solution that may ensure that the deployment and operation of the machine learning model comply with data security and compliance requirements.

In addition, the user side 11 cannot directly verify the security of the cloud platform 12. In this case, it is critical whether the provider of the cloud platform 12 may "prove its innocence", that is, provide a solution in which even the background administrator or the operation and maintenance personnel of the cloud vendor cannot view or use the proprietary model deployed by the user side 11. Therefore, how to securely store, deploy, and run the machine learning model of the user side in the public cloud environment, and ensure that even the cloud platform provider cannot peek at the user model has become an urgent problem to be solved.

According to the embodiments of the present disclosure, an improved solution for securely deploying a model is provided. In this solution, a container service first receives, from a user side, a deployment request for a machine learning model, where the deployment request includes at least a model identification of the machine learning that is encrypted model and a key identification of a key used to encrypt the machine learning model. Then, the container service obtains the machine learning model that is encrypted and the key based on the deployment request. The container service decrypts, in a trusted execution environment, the machine learning model that is encrypted using the key to obtain the machine learning model. Then, the container service securely deploys the machine learning model in the trusted execution environment.

Through the above process, the container service running in the trusted execution environment may implement the entire process of deploying and running a machine learning model of a user in the trusted execution environment. In addition, through a key management mechanism, key leakage may be prevented and the security of the securely deploying a model may be further ensured. With these improvements, encryption protection in the entire lifecycle of the model may be implemented, and the risk of data leakage of data resources during the deployment and running process may be reduced, thereby meeting higher requirements for privacy protection and data security.

FIG. 1B is a schematic diagram of an example environment 100 in which the embodiments of the present disclosure may be implemented. As shown in FIG. 1B, the example environment 100 may include a user-side device 120 of a user 140 and a cloud environment 101. In the embodiments of the present disclosure, the term "user" may refer to an entity at any appropriate granularity, for example, an individual user, a collective user, an organizational user, an enterprise user, and the like. An example of the user 140 is a tenant.

As shown in FIG. 1B, a trusted execution environment 115 may be deployed in the cloud environment 101. The trusted execution environment (TEE) is a hardware-based security technology that constructs a secure computing environment isolated from the outside by dividing a secure part and a non-secure part. The secure computing environment may ensure the confidentiality and integrity of data and code loaded in the trusted execution environment 115. The trusted execution environment 115 is isolated from a normal environment and has a higher security level, and is suitable for performing processing on sensitive data. Private cloud computing (PCC) may run in the trusted execution environment 115. The private cloud computing is an on-cloud security computing framework based on the TEE, and aims to build a set of security computing services trusted by users, provide users with a secure and reliable on-cloud running environment, and ensure the security of the entire link of end-cloud collaboration.

A container service 112 may run in the trusted execution environment 115. The container service 112 may be responsible for securely pulling, decrypting, and executing, in the PCC, a task (such as a model inference task) submitted by the user-side device 120. Because the container service 112 runs in the trusted execution environment 115, a computing task in a container will not be exposed to an external system or service, thereby ensuring the confidentiality and integrity of the computing process.

A key management service 114 may be deployed in the trusted execution environment 115. With the key management service, a key of the user 140 obtained from the user-side device 120 may be stored in the key management service 114. An example of the key management service may be a trusted key management service (TKS). The TKS is a secure key service running in the PCC, and aims to provide users with key management and proxy services based on hardware protection.

The container service 112 may communicate with the key management service 114. For example, the container service 112 may send a key request to the key management service 114 to obtain a target key to encrypt or decrypt knowledge.

In some embodiments, the trusted execution environment 115 may communicate with the user-side device 120 to implement data access and analysis. The user-side device 120 may be any suitable type of computing device, such as a server or a terminal device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including accessories and peripherals of these devices or any combination thereof. In some embodiments, the user-side device 120 may also support any type of user-specific interface (such as a "wearable" circuit, etc.).

The cloud environment 101 may include an independent physical server, a server cluster or a distributed system including a plurality of physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The trusted execution environment 115 may be implemented by using a host device in the cloud environment 101. The host device may include , for example, a computing system/server, such as a mainframe, an edge computing node, or a computing device in a cloud environment. The host device may provide the user-side device 120 with a background service for data management.

A communication connection may be established between the cloud environment 101 and the user-side device 120. The communication connection may be established in a wired or wireless manner. The communication connection may include but is not limited to a Bluetooth connection, a mobile network connection, a universal serial bus connection, a Wi-Fi connection, etc. The embodiments of the present disclosure are not limited in this regard.

It should be understood that the structure and function of each element in the environment 100 are described for illustrative purposes only, and are not intended to imply any limitation on the scope of the present disclosure. In other words, the structure, function, number, and linkage relationship of the elements in the environment 100 may be changed according to actual needs. The present disclosure is not limited in this regard.

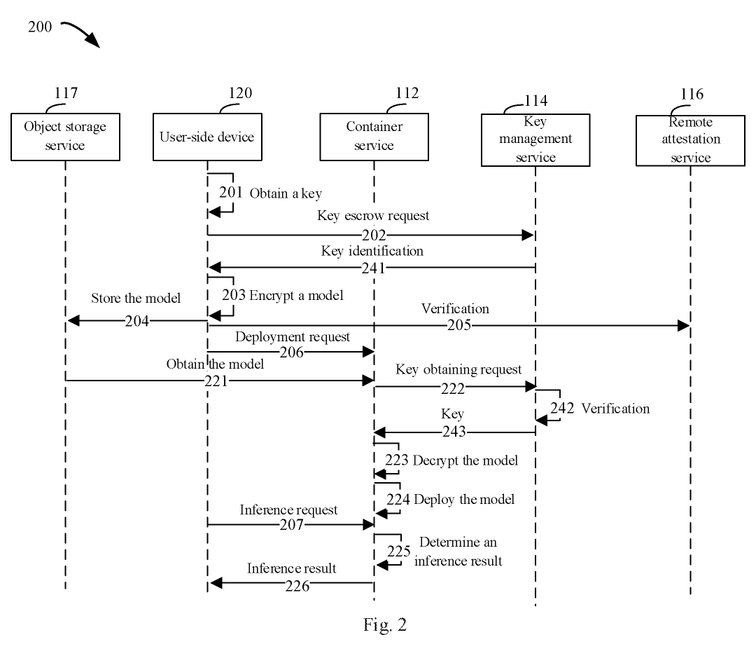

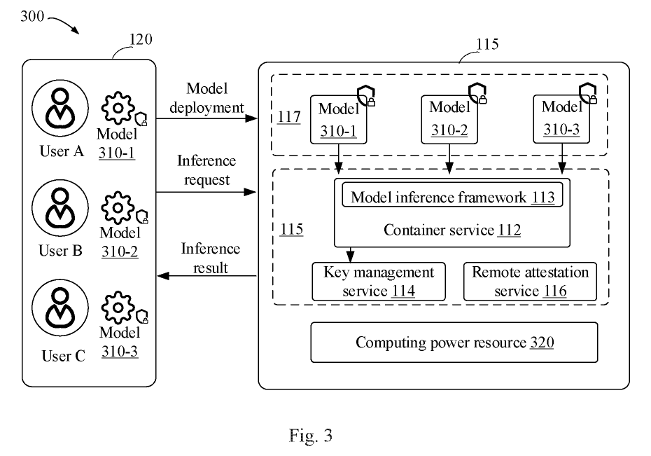

Some example embodiments of the present disclosure are described in detail below with reference to the examples in FIG. 2 and FIG. 3.

FIG. 2 shows an example interaction process 200 of securely deploying a model according to some embodiments of the present disclosure. The interaction process 200 mainly includes the user-side device 120, the container service 112, and the key management service 114. FIG. 3 shows an example interaction scenario 300 of securely deploying a model according to some embodiments of the present disclosure. The interaction scenario 300 mainly includes the user-side device 120, the container service 112, and the key management service 114. For ease of discussion, the interaction process 200 and the interaction scenario 300 will be described with reference to the environment 100 in FIG. 1B. It may be understood that the container service 112 is only exemplary, and the methods and steps implemented at the container service 112 described herein may also be applied to other services or functions.

As shown in FIG. 3, the user-side device 120 may include a machine learning model corresponding to the user. For example, the user-side device corresponding to user A may include a proprietary machine learning model 310-1 thereof, the user-side device corresponding to user B may include a proprietary machine learning model 310-2 thereof, and the user-side device corresponding to user C may include a proprietary machine learning model 310-3 thereof. It may be understood that the number of users and machine learning models shown in FIG. 3 is only exemplary, and is not intended to be any limitation.

In the embodiments of the present disclosure, the machine learning model may be any suitable type of model. In some embodiments, the machine learning model may be built based on a deep neural network model or a language model (LM). In some embodiments, the machine learning model may be a large language model (LLM). In some embodiments, the machine learning model may be an LLM-based model that may process model inputs in a text modality (e.g., a natural language and/or a machine language) and/or in a non-text modality (e.g., an image, a voice, a video, etc.), and generate a desired output based on the model input and a prompt.

In some embodiments, the user-side device 120 may obtain (201) a proprietary key corresponding to the user. For example, the key may be obtained based on a user input or generated based on a feature rule (such as random generation).

In some embodiments, as shown in FIG. 2, before uploading a machine learning model to be deployed to the cloud environment 101, the user-side device 120 may encrypt (203), using the key, the machine learning model to be deployed to obtain an encrypted machine learning model. For example, the user-side device 120 may encrypt the machine learning model to be deployed by calling a software development kit (SDK) provided by a local or other encryption service. Through encryption, the user-side device 120 may obtain the encrypted machine learning model. The user-side device 120 encrypts the machine learning model before deploying the model, which can ensure that the model cannot be viewed or used by other services or the provider of the cloud environment when the model is deployed and runs on the cloud.

In some embodiments, the user-side device 120 may store (204) the encrypted machine learning model and determine a model identification of the encrypted machine learning model. For example, the user-side device 120 may upload the encrypted machine learning model to cloud storage. After the uploading is successful, the user-side device 120 may obtain a unique model identification of the model. The model identification may be used to retrieve a corresponding encrypted model in the subsequent deployment and invocation process of the machine learning model. In some embodiments, the model identification may be in the form of a uniform resource locator (URL). By storing the encrypted machine learning model, unauthorized access can be prevented. Even if an unauthorized user or service obtains the model identification (URL), it cannot view or invoke the corresponding machine learning model.

Referring to FIG. 3, the user-side device 120 may store (204) the encrypted machine learning model in an object storage service 117, specifically in storage space for the model. The object storage service (OSS) is a cloud storage technology that may be used to store and manage unstructured data such as files, pictures, videos, and models. In some embodiments of the present disclosure, the object storage service 117 is used to store the encrypted machine learning model, and the object storage service 117 is independent of object storage services for other user sides. This means that object storage service of each user is independent, and data of each user is stored in their own logical or physical storage space. In this way, data of different users will not be mixed together, thereby ensuring that the model can be securely accessed when needed.

As shown in FIG. 2, in some embodiments, based on the obtained key of the user, the user-side device 120 may send (202) to the key management service 114 a key escrow request for the key used to encrypt the machine learning model to be deployed. For example, in order to ensure that the model encryption key is not leaked and only a trusted environment can access the key, the user-side device 120 may submit a key escrow request to the key management service 114. Through the key escrow request, the key management service 114 manages the key on behalf of the user-side device. The key escrow request includes at least the encryption key itself (used to encrypt the model). Alternatively or additionally, the key escrow request may include identity authentication information of the user-side device 120 (to ensure that only an authorized user or service may manage or request the key).

Continuing to refer to FIG. 2, the key management service 114 determines a key identification of the key in response to receiving the key escrow request sent by the user-side device 120. For example, the key management service 114 may determine a unique identification of the key (i.e., the key identification, Key ID) for subsequent retrieval of the corresponding key. In some examples, in order to further improve the security of the key, the key management service 114 may not directly store the plaintext key, but encrypt the key using a key encryption key (KEK) and other mechanisms and store it in a database. After determining the key identification, the key management service 114 sends (241) the key identification to the user-side device 120. The user-side device 120 may store the received key identification, and use the key identification in a subsequent model deployment or invocation request to request the corresponding key.

In some embodiments, the key obtaining request further includes an access control policy for the key. The access control policy indicates performing verification on a requester of the key. For example, when requesting to escrow the key used to encrypt the machine learning model, the user-side device 120 may configure the access control policy for the key to ensure that only a requester that meets the authorization condition may obtain the key. The access control policy may indicate, for example, a verification method for the key requester and restrict the key requester, an environment of the key requester, access time, and the like. After configuring the access control policy for the key, the key management service 114 may strictly verify the key requester based on the policy, thereby further improving data security.

After completing a series of operations such as machine learning model encryption and storage, key escrow and access restriction policy configuration, the user-side device 120 may send a deployment request to the container service 112 to deploy the machine learning model on the cloud. Referring to FIG. 3, the process of machine model deployment may be performed by the container service 112 running in the trusted execution environment 115. The container service 112 runs in the trusted execution environment 115, which can ensure that the decryption and inference process in the container service 112 cannot be viewed and invoked by other users, services, or even the cloud environment provider without permission.

Returning to FIG. 2, in some embodiments, the user-side device 120 may verify (205) the container service before sending the deployment request. For example, the user-side device 120 may verify (205) the container service 112 using a remote attestation service 116. If it is determined that the container service 112 passes the verification, the user-side device 120 may send (206) the deployment request to the container service.

As an example, before sending the model deployment request, the user-side device 120 may want to ensure that the container service 112 runs in a secure and trusted environment to avoid the model being decrypted or running in an untrusted environment. The cloud environment provider needs to prove to the user that its computing environment is trusted, that is, the user's encrypted model and data will not be accessed or misused in an unauthorized environment. The user-side device 120 cannot directly control or manage the cloud environment, and therefore may verify the container service 112 through the remote attestation service 116, thereby achieving the purpose of the cloud environment provider to "prove its innocence".

The verification of the container service 112 by the remote attestation service 116 may include, for example, verifying whether the container service 112 runs in the trusted execution environment and verifying whether the container service 112 is trusted (for example, whether the container service 112 is complete and unmodified). If the container service 112 fails to pass the verification of the remote attestation service 116, the user-side device 120 may not send the deployment request to prevent the machine learning model from being decrypted and used in an untrusted environment. If the container service 112 passes the verification of the remote attestation service 116, the user-side device 120 may send the deployment request to the container service 112. In some embodiments, the remote attestation service 116 may be deployed in the trusted execution environment 115 to improve the security of verification.

Returning to FIG. 2, the user-side device 120 may send (206) the deployment request to the container service 112, where the deployment request includes at least the model identification of the machine learning model that is encrypted and the key identification of the key used to encrypt the model. The container service 112 receives the deployment request for the machine learning model from the user-side device 120, and obtains the machine learning model that is encrypted and the key based on the deployment request.

In some embodiments, the container service 112 obtains (221), using the model identification, the machine learning model that is encrypted from the object storage service. The container service 112 may be responsible for pulling the user's machine learning model that is encrypted from the object storage service 117 and ensuring that the model is securely deployed in the trusted execution environment 115.

In some embodiments, the container service 112 determines, based on the model identification, the storage space for the machine learning model that is encrypted in the object storage service. Then, the container service 112 loads the machine learning model that is encrypted from the storage space into the trusted execution environment. For example, after receiving the deployment request sent by the user-side device, the container service 112 may parse the model identification (URL) therein to determine the specific storage location of the machine learning model that is encrypted stored in the object storage service. Using the parsed model identification, the container service 112 may pull a file of the model that is encrypted file through a secure storage access interface. Referring to FIG. 3, after the pulling is completed, the container service 112 may store the file of the machine learning model that is encrypted in the trusted execution environment 115 to prepare for subsequent decryption and deployment. Because the stored data is encrypted, even if the background administrator or operation and maintenance personnel of the cloud environment provider accesses the model file, the specific content of the model cannot be interpreted.

Continuing to refer to FIG. 2, the container service 112 may send (222) the key obtaining request to the key management service 114, where the key obtaining request includes at least the key identification. After obtaining the machine learning model that is encrypted from the object storage service 117 and loading it into the trusted execution environment 115, the container service 112 still cannot directly deploy the model because the model is encrypted. The container service 112 may send the key obtaining request to the key management service 114 to obtain the key corresponding to the model based on the key identification.

In some embodiments, the key obtaining request may further include attestation information of the container service 112. The attestation information indicates the trustworthiness of the container service 112 and an execution environment of the container service 112. In order to ensure security, the key request process may also be accompanied by the trustworthiness attestation information of the container service 112 itself, so that the key management service 114 may verify its legitimacy.

In some embodiments, the key management service 114 receives, from the container service 112, the key obtaining request including the key identification of the key. Then, the key management service 114 may verify (242) the container service 112. For example, the key management service 114 may verify the container service 112 based on an access restriction policy configured by the user-side device 120. Alternatively or additionally, the key management service 114 may verify the container service 112 using the remote attestation service 116. If it is determined that the container service 112 passes the verification, the key management service 114 may send (243) the key to the container service 112 to decrypt the machine learning model.

In some embodiments, the key management service 114 may determine, based on the attestation information of the container service 112, whether the container service 112 is a trusted requester and whether the container service runs in the trusted execution environment. The attestation information may be used to prove the security of the container service 112. Exemplarily, the attestation information may include information such as hardware trusted computing base (Trusted Computing Base, TCB) information, an application measurement value, application custom data, and a hardware signature of the container service 112. The application measurement value usually refers to a set of values obtained after measuring an application or its components in the trusted execution environment. These values are used to verify the integrity and authenticity of the container service 112 to ensure that the container service 112 has not been tampered with. The application custom data usually refers to data defined by the application according to its own needs and included in the attestation information. These data may be a configuration specific to the container service 112, identification information, or other content that helps to prove the security and trustworthiness of the container service 112. The verification method described herein is only exemplary, and is not intended to be any limitation. The embodiments of the present disclosure are not limited in this regard.

If the container service 112 passes the verification, the key management service 114 may send (243) the corresponding key to the container service 112 based on the key identification. Correspondingly, the container service 112 may receive the key from the key management service 114. The container service 112 may decrypt (223), based on the received key, the encrypted machine learning model to be deployed.

In some embodiments, after receiving the key, the container service 112 may decrypt, in the trusted execution environment 115, the machine learning model that is encrypted using the key to obtain the decrypted machine learning model. Then, the container service 112 may deploy (224) the machine learning model obtained through decryption in the trusted execution environment 115. Referring to FIG. 3, the running environment of the container service 112 is the trusted execution environment 115 verified by the remote attestation service 116 and the key management service 114. In addition, the whole operation of decryption and deployment is completed inside the trusted execution environment 115 and will not be exposed to an external system. In this way, the security of the model is further ensured.

In some embodiments, after completing the model deployment, the user-side device 120 may send (207) an encrypted inference request for the machine learning model to the container service 112. The inference request includes at least encrypted target data. The target data may be data to be processed. Correspondingly, the container service 112 may receive the inference request from the user-side device 120. In the trusted execution environment 115, the container service 112 may determine (225) an inference result using the machine learning model based on the target data. Then, the container service 112 may send (226) the inference result that is encrypted to the user-side device 120.

As an example, the user-side device 120 needs to perform inference on the target data (such as a to-be-processed text, image, log data, etc.) using the machine learning model. In order to prevent data leakage, the user-side device 120 may not directly send the target data in plaintext, but first encrypt the target data. Subsequently, the encrypted inference request is sent to the container service 112 running in the trusted execution environment 115. The container service 112 may receive the encrypted inference request in the trusted execution environment 115 and perform identity authentication to ensure that the request comes from a legitimate user-side device 120. Only an inference request that meets the security policy will be processed, otherwise the container service 112 can refuse to execute the inference request. The container service 112 may decrypt the target data in the trusted execution environment 115 and perform inference calculation on the decrypted target data. The container service 112 can use the computing power resource 320 on the cloud, such as a graphics processing unit (GPU) supporting confidential computing, to perform inference calculation on the decrypted target data using the deployed machine learning model in the trusted execution environment 115. The decryption process and the inference calculation process are still performed inside the trusted execution environment 115, and other users, services, or cloud vendors cannot access the data therein. After completing the inference, the container service 112 may send (226) the inference result that is encrypted to the user-side device 120. The inference result may not be returned in plaintext, but re-encrypted inside the trusted execution environment 115 to further ensure data security.

In some embodiments, the user-side device 120 may further indicate, in the deployment request, a model inference framework 113 of the machine learning model to be deployed. An example of the model inference framework 113 may include vLLM, SGlang, etc. The container service 112 may deploy the machine learning model in the trusted execution environment 115 based on the model inference framework 113 indicated in the deployment request. The model inference framework 113 is a key component that runs an inference task after the model is deployed, and may be responsible for loading the deployed machine learning model and executing the inference task to ensure that the model can efficiently and securely process the inference request of the user. For example, the container service 112 may support multiple inference frameworks. The user-side device 120 may indicate a selection of an inference framework from the multiple inference frameworks in the sent deployment request. The container service 112 may deploy the machine learning model in the trusted execution environment 115 using the selected inference framework. That is, the container service 112 may support the user to independently select an appropriate inference framework.

In some examples, if the user-side device 120 needs to update the deployed machine learning model, the foregoing complete model deployment process may be re-executed. For example, the user fine-tunes, optimizes, or upgrades the model, which means that the model parameters have changed, and the entire deployment process needs to be re-executed to ensure that a new version of the machine learning model may be securely stored, deployed, and run.

In some examples, when the user-side device 120 completes the model update, an old version of the machine learning model may no longer be needed. Therefore, the user-side device 120 may manually destroy the model to release storage space and improve security. The model destruction process may involve the user-side device 120 triggering the deletion of a model file of the old version inside the container service 112, and the deletion of the model and a model identification file in the object storage service 117, thereby releasing resources and improving security. Alternatively or additionally, the model destruction process may further involve the user-side device 120 triggering the deletion of a key of the model to be destroyed in the key management service 114 and the deletion of an access restriction policy corresponding to the key in the remote attestation service 116.

In conclusion, in the embodiments of the present disclosure, a set of secure and efficient cloud model deployment and running mechanisms are constructed through the confidential container service, key management service, and the like in the trusted execution environment. The whole process of model decryption, deployment, and inference is only performed inside the trusted execution environment, and even the background administrator or operation and maintenance personnel of the cloud environment provider cannot access the model or inference data. In this way, the user's proprietary machine learning model can be strictly protected in the cloud environment. In this way, the proprietary machine learning model can be securely host, deploy, and run on the cloud environment by the user, thereby ensuring the privacy and security of the model and data while fully utilizing the advantages of cloud computing power.

In some embodiments of the present disclosure, in addition to the secure deployment and inference of the machine learning model, this method of full-link encryption protection in the process of data storage and computing on the cloud is also applicable to other business objects in cloud business scenarios that need to be hosted, managed, and run on the cloud environment, for example, a private interface or service deployed on the cloud, a computing task that needs to call cloud computing resources and whose data is highly private, a scenario of multi-party collaboration for data processing, and so on. Various embodiments described above with reference to the machine learning model may be applied to other types of business objects.

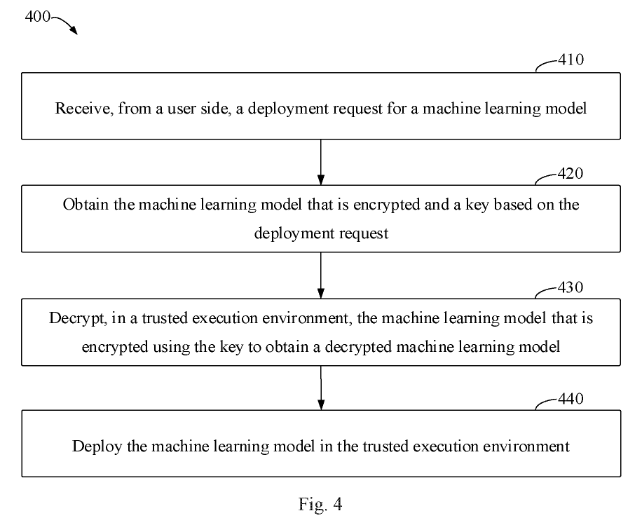

FIG. 4 is a flowchart of a process 400 for securely deploying a model according to some embodiments of the present disclosure. The process 400 may be applied to the container service 112. The process 400 will be described below with reference to FIG. 1B.

At block 410, the container service 112 receives, from a user side, a deployment request for a machine learning model. The deployment request includes at least a model identification of the machine learning model that is encrypted and a key identification of a key used to encrypt the machine learning model.

At block 420, the container service 112 obtains the machine learning model that is encrypted and the key based on the deployment request.

At block 430, the container service 112 decrypts, in a trusted execution environment, the machine learning model that is encrypted using the key to obtain the machine learning model.

At block 440, the container service 112 deploys the machine learning model in the trusted execution environment.

In some embodiments, the obtaining the machine learning model that is encrypted and the key includes: obtaining, using the model identification, the machine learning model that is encrypted from an object storage service; and obtaining, using the key identification, the key from a key management service in the trusted execution environment.

In some embodiments, the machine learning model is stored by the user side into the object storage service, and the key is escrowed by the user side by indicating the key management service.

In some embodiments, the obtaining the machine learning model that is encrypted includes: determining, based on the model identification, storage space for the machine learning model that is encrypted in the object storage service; and loading the machine learning model that is encrypted from the storage space into the trusted execution environment.

In some embodiments, the model identification is a uniform resource locator that identifies the machine learning model that is encrypted in the storage space. In some embodiments, the object storage service for the user side is independent of object storage services for other user sides.

In some embodiments, the obtaining the key from the key management service includes: sending a key obtaining request to the key management service, the key obtaining request including at least the key identification and attestation information of the container service, the attestation information indicating trustworthiness of the container service and an execution environment of the container service; and receiving the key from the key management service, the key being sent by the key management service after verifying the container service.

In some embodiments, the process 400 further includes: receiving, from the user side, an encrypted inference request for the machine learning model, the data inference request including at least target data; determining, in the trusted execution environment, an inference result using the machine learning model based on the target data; and sending the inference result that is encrypted to the user side.

In some embodiments, the deployment request further includes a selection of an inference framework from a plurality of inference frameworks, and the deploying the machine learning model in the trusted execution environment includes: deploying, according to the selected inference framework, the machine learning model in the trusted execution environment.

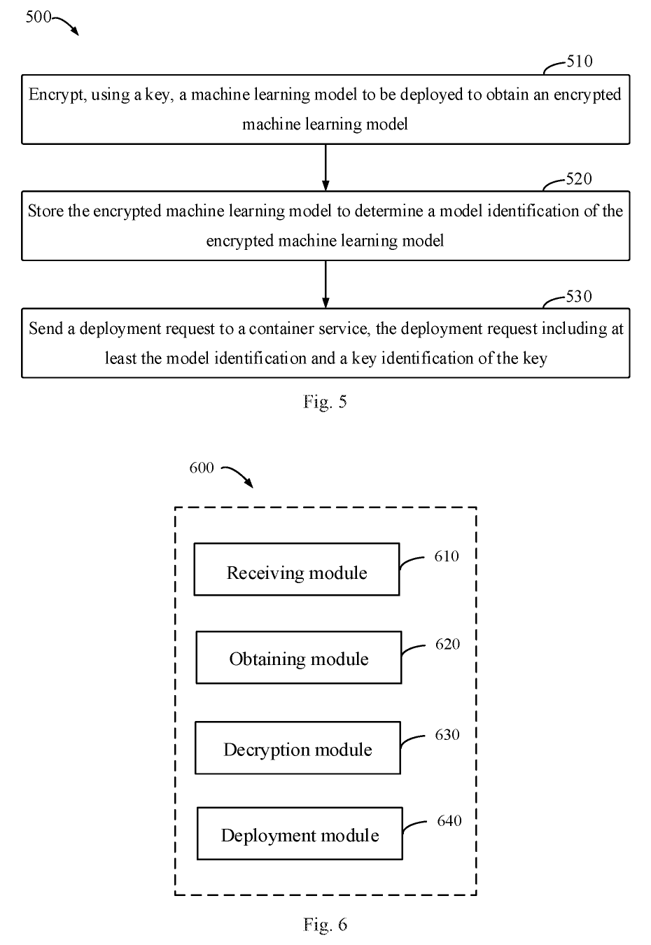

FIG. 5 is a flowchart of a process 500 for securely deploying a model according to some embodiments of the present disclosure. The process 500 may be applied to the user-side device 120. The process 500 will be described below with reference to FIG. 1B.

At block 510, the user-side device 120 encrypts, using a key, a machine learning model to be deployed to obtain an encrypted machine learning model.

At block 520, the user-side device 120 stores the encrypted machine learning model to determine a model identification of the encrypted machine learning model.

At block 530, the user-side device 120 sends a deployment request to a container service, the deployment request including at least the model identification and a key identification of the key.

In some embodiments, the storing the encrypted machine learning model includes: storing the encrypted machine learning model into storage space for the encrypted machine learning model in an object storage service, where the object storage service is independent of object storage services for other user sides.

In some embodiments, the process 500 further includes: sending a key escrow request for the machine learning model to a key management service, the key escrow request including the key; and receiving the key identification of the key from the key management service.

FIG. 6 is a schematic structural block diagram of an apparatus 600 for securely deploying a model according to some embodiments of the present disclosure. The apparatus 600 may be applied to the container service 112. Each module/component in the apparatus 600 may be implemented by hardware, software, firmware, or any combination thereof.

As shown in FIG. 6, the apparatus 600 includes a receiving module 610 configured to receive, from a user side, a deployment request for a machine learning model, the deployment request including at least a model identification of the machine learning model that is encrypted and a key identification of a key used to encrypt the machine learning model; an obtaining module 620 configured to obtain the machine learning model that is encrypted and the key based on the deployment request; a decryption module 630 configured to decrypt, in a trusted execution environment, the machine learning model that is encrypted using the key to obtain the machine learning model; and a deployment module 640 configured to deploy the machine learning model in the trusted execution environment.

In some embodiments, the obtaining module 620 is further configured to: obtain, using the model identification, the machine learning model that is encrypted from an object storage service; and obtain, using the key identification, the key from a key management service in the trusted execution environment.

In some embodiments, the machine learning model is stored by the user side into the object storage service, and the key is escrowed by the user side by indicating the key management service.

In some embodiments, the obtaining module 620 is further configured to: determine, based on the model identification, storage space for the machine learning model that is encrypted in the object storage service; and load the machine learning model that is encrypted from the storage space into the trusted execution environment.

In some embodiments, the model identification is a uniform resource locator that identifies the machine learning model that is encrypted in the storage space.

In some embodiments, the object storage service for the user side is independent of object storage services for other user sides.

In some embodiments, the obtaining module 620 is further configured to: send a key obtaining request to the key management service, the key obtaining request including at least the key identification and attestation information of the container service, the attestation information indicating trustworthiness of the container service and an execution environment of the container service; and receive the key from the key management service, the key being sent by the key management service after verifying the container service.

In some embodiments, the apparatus 600 further includes an inference module 650 configured to: receive, from the user side, an encrypted inference request for the machine learning model, the data inference request including at least target data; determine, in the trusted execution environment, an inference result using the machine learning model based on the target data; and send the inference result that is encrypted to the user side.

In some embodiments, the deployment request further includes a selection of an inference framework from a plurality of inference frameworks. The deployment module 640 is further configured to deploy, according to the selected inference framework, the machine learning model in the trusted execution environment.

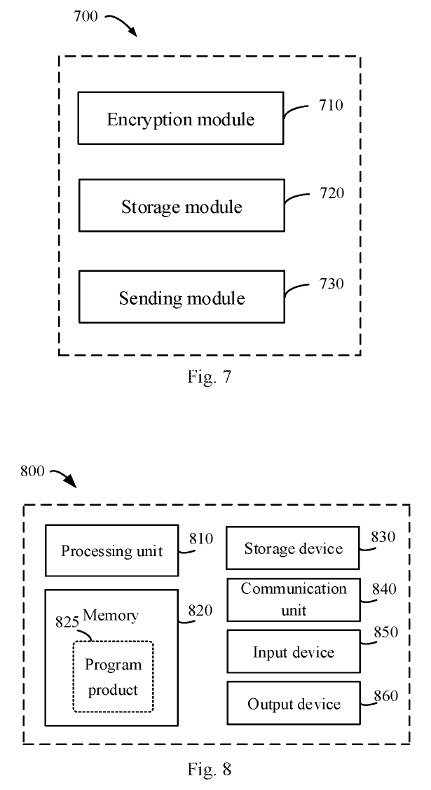

FIG. 7 is a schematic structural block diagram of an apparatus 700 for securely deploying a model according to some embodiments of the present disclosure. The apparatus 700 may be applied to the user-side device 120. Each module/component in the apparatus 700 may be implemented by hardware, software, firmware, or any combination thereof.

As shown in FIG. 7, the apparatus 700 includes an encryption module 710 configured to encrypt, using a key, a machine learning model to be deployed to obtain an encrypted machine learning model; a storage module 720 configured to store the encrypted machine learning model to determine a model identification of the encrypted machine learning model; and a sending module 730 configured to send a deployment request to a container service, the deployment request including at least the model identification and a key identification of the key.

In some embodiments, the storage module 720 is further configured to: store the encrypted machine learning model into storage space for the encrypted machine learning model in an object storage service, where the object storage service is independent of object storage services for other user sides.

In some embodiments, the apparatus 700 further includes an escrow module configured to: send a key escrow request for the machine learning model to a key management service, the key escrow request including the key; and receive the key identification of the key from the key management service.

The units and/or modules included in the apparatus 600 and the apparatus 700 may be implemented in various manners, including software, hardware, firmware, or any combination thereof. In some embodiments, one or more units and/or modules may be implemented using software and/or firmware, for example machine executable instructions stored on a storage medium. In addition to machine executable instructions or as an alternative, some or all units and/or modules in the apparatus 700 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and so on.

FIG. 8 is a block diagram of an electronic device 800 in which one or more embodiments of the present disclosure may be implemented. It should be understood that the electronic device 800 shown in FIG. 8 is only exemplary, and should not constitute any limitation on the function and scope of the embodiments described herein.

As shown in FIG. 8, the electronic device 800 is in the form of a general-purpose electronic device. Components of the electronic device 800 may include, but are not limited to, one or more processors or processing units 810, a memory 820, a storage device 830, one or more communication units 840, one or more input devices 850, and one or more output devices 860. The processing unit 810 may be an actual or virtual processor, and may perform various processing based on a program stored in the memory 820. In a multi-processor system, a plurality of processing units execute computer executable instructions in parallel to improve the parallel processing capability of the electronic device 800.

The electronic device 800 typically includes a plurality of computer storage medium. Such medium may be any available medium accessible by the electronic device 800, including, but not limited to, volatile and non-volatile medium, and removable and non-removable medium. The memory 820 may be a volatile memory (for example, a register, cache, or a random access memory (RAM)), a non-volatile memory (such as a read-only memory (ROM), an electrically erasable programmable read-only memory (EEPROM), or a flash memory), or any combination thereof. The storage device 830 may be a removable or non-removable medium, and may include a machine readable medium such as a flash drive, a disk, or any other medium, which may be used to store information and/or data and may be accessed within the electronic device 800.

The electronic device 800 may further include additional removable/non-removable, volatile/non-volatile memory medium. Although not shown in FIG. 8, a disk driver for reading from or writing to a removable, non-volatile disk (such as a "floppy disk"), and an optical disk driver for reading from or writing to a removable, non-volatile optical disk may be provided. In these cases, each driver may be connected to a bus (not shown) by one or more data medium interfaces. The memory 820 may include a computer program product 825 having one or more program modules configured to perform various methods or acts of various embodiments of the present disclosure.

The communication unit 840 implements communication with other electronic devices through a communication medium. Additionally, the functions of the components of the electronic device 800 may be implemented by a single computing cluster or a plurality of computing machines, which may communicate through a communication connection. Therefore, the electronic device 800 may use a logical connection with one or more other servers, a network personal computer (PC), or another network node to operate in a networked environment.

The input device 850 may be one or more input devices, such as a mouse, a keyboard, or a tracking ball. The output device 860 may be one or more output devices, such as a display, a speaker, or a printer. The electronic device 800 may further communicate, as needed, with one or more external devices (not shown) such as a storage device or a display device, with one or more devices that enable a user to interact with the electronic device 800, or with any devices (e.g., a network card or a modem) that enable the electronic device 800 to communicate with one or more other electronic devices through the communication unit 840. Such communication may be performed via input/output (I/O) interfaces (not shown).

According to an exemplary implementation of the present disclosure, there is provided a computer-readable storage medium having computer executable instructions stored thereon, the computer executable instructions being executed by a processor to implement the method described above. According to an exemplary implementation of the present disclosure, there is further provided a computer program product tangibly stored on a non-transitory computer-readable medium and including computer executable instructions, the computer executable instructions being executed by a processor to implement the method described above.

Various aspects of the present disclosure are described herein with reference to flowcharts and/or block diagrams of methods, apparatuses, devices, and computer program products implemented according to the present disclosure. It should be understood that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a dedicated computer, or other programmable model deployment apparatus to produce a machine, such that the instructions, when executed by the processing unit of the computer or other programmable model deployment apparatus, produce an apparatus for implementing a function/action specified in one or more blocks of the flowcharts and/or block diagrams. These computer-readable program instructions may also be stored in a computer-readable storage medium, the instructions causing a computer, a programmable model deployment apparatus, and/or other devices to operate in a particular manner, such that the computer-readable medium having the instructions stored thereon includes an article of manufacture including instructions for implementing various aspects of the function/action specified in one or more blocks of the flowcharts and/or block diagrams.

The computer-readable program instructions may be loaded onto a computer, another programmable model deployment apparatus, or another device, causing a series of operations and steps to be performed on the computer, another programmable model deployment apparatus, or another device, to produce a computer-implemented process, such that the instructions executed on the computer, another programmable model deployment apparatus, or another device implement the function/action specified in one or more blocks of the flowcharts and/or block diagrams.

The flowcharts and block diagrams in the drawings illustrate the architecture, functionality, and operation of possible implementations of the system, method and computer program product according to various implementations of the present disclosure. In this regard, each block in the flowchart or block diagrams may represent a module, program segment, or portion of instructions, which includes one or more executable instructions for implementing a specified logical function. In some alternative implementations, functions indicated in the blocks may occur in an order different from that indicated in the drawings. For example, two consecutive blocks may, in fact, be executed substantially concurrently, or the blocks may sometimes be executed in the reverse order, depending upon the functionality involved. It also should be noted that each block of the block diagrams and/or flowcharts, or combinations of blocks in the block diagrams and/or flowcharts, may be implemented in special purpose hardware-based systems that perform specified functions or acts, or combinations of special purpose hardware and computer instructions.

Various implementations of the present disclosure have been described above. The above description is exemplary, not exhaustive, and is not limited to the disclosed implementations. Many modifications and variations will be apparent to those of ordinary skill in the art without departing from the scope and spirit of the described implementations. The choice of terms used herein is intended to best explain the principles of the implementations, the practical application or improvement to the technology in the market, or to enable other ordinary skilled persons in the art to understand the implementations disclosed herein.

1. A method for securely deploying a model, comprising:
receiving, from a user side, a deployment request for a machine learning model, the deployment request comprising at least a model identification of the machine learning model that is encrypted and a key identification of a key used to encrypt the machine learning model;
obtaining the machine learning model that is encrypted and the key based on the deployment request;
decrypting, in a trusted execution environment, the machine learning model that is encrypted using the key to obtain the machine learning model; and
deploying the machine learning model in the trusted execution environment.

2. The method according to claim 1, wherein the obtaining the machine learning model that is encrypted and the key comprises:
obtaining, using the model identification, the machine learning model that is encrypted from an object storage service; and
obtaining, using the key identification, the key from a key management service in the trusted execution environment.

3. The method according to claim 2, wherein the machine learning model that is encrypted is stored by the user side into the object storage service, and the key is escrowed by the user side by indicating the key management service.

4. The method according to claim 2, wherein the obtaining the machine learning model that is encrypted comprises:
determining, based on the model identification, storage space for the machine learning model that is encrypted in the object storage service, wherein the model identification is a uniform resource locator that identifies the machine learning model that is encrypted in the storage space; and
loading the machine learning model that is encrypted from the storage space into the trusted execution environment.

5. The method according to claim 4, wherein the object storage service for the user side is independent of object storage services for other user sides.

6. The method according to claim 2, wherein the method is performed by a container service, and the obtaining the key from the key management service comprises:
sending a key obtaining request to the key management service, the key obtaining request comprising at least the key identification and attestation information of the container service, the attestation information indicating trustworthiness of the container service and an execution environment of the container service; and
receiving the key from the key management service, the key being sent by the key management service after verifying the container service.

7. The method according to claim 1, further comprising:
receiving, from the user side, an encrypted inference request for the machine learning model, the inference request comprising at least first data;
determining, in the trusted execution environment, an inference result using the machine learning model based on the first data; and
sending the inference result that is encrypted to the user side from the trusted execution environment.

8. The method according to claim 1, wherein the deployment request further comprises a selection of an inference framework from a plurality of inference frameworks, and the deploying the machine learning model in the trusted execution environment comprises:
deploying, according to a selected inference framework, the machine learning model in the trusted execution environment.

9. A method for securely deploying a model, comprising:
encrypting, using a key, a machine learning model to be deployed to obtain an encrypted machine learning model;
storing the encrypted machine learning model to determine a model identification of the encrypted machine learning model; and
sending a deployment request to a container service, the deployment request comprising at least the model identification and a key identification of the key.

10. The method according to claim 9, wherein the storing the encrypted machine learning model comprises:
storing the encrypted machine learning model into storage space for the encrypted machine learning model in an object storage service, wherein the object storage service is independent of object storage services for other user sides.

11. The method according to claim 9, further comprising:
sending a key escrow request for the machine learning model to a key management service, the key escrow request comprising the key; and
receiving the key identification of the key from the key management service.

12. An electronic device, comprising:
at least one processor; and
at least one memory, coupled to the at least one processor and storing instructions executable by the at least one processor, wherein the instructions, when executed by the at least one processor, cause the electronic device to perform a method for securely deploying a model, wherein the method comprises:
receiving, from a user side, a deployment request for a machine learning model, the deployment request comprising at least a model identification of the machine learning model that is encrypted and a key identification of a key used to encrypt the machine learning model;
obtaining the machine learning model that is encrypted and the key based on the deployment request;
decrypting, in a trusted execution environment, the machine learning model that is encrypted using the key to obtain the machine learning model; and
deploying the machine learning model in the trusted execution environment.

13. The electronic device according to claim 12, wherein the obtaining the machine learning model that is encrypted and the key comprises:
obtaining, using the model identification, the machine learning model that is encrypted from an object storage service; and
obtaining, using the key identification, the key from a key management service in the trusted execution environment.

14. The electronic device according to claim 13, wherein the machine learning model that is encrypted is stored by the user side into the object storage service, and the key is escrowed by the user side by indicating the key management service.

15. The electronic device according to claim 13, wherein the obtaining the machine learning model that is encrypted comprises:
determining, based on the model identification, storage space for the machine learning model that is encrypted in the object storage service, wherein the model identification is a uniform resource locator that identifies the machine learning model that is encrypted in the storage space; and
loading the machine learning model that is encrypted from the storage space into the trusted execution environment.

16. The electronic device according to claim 15, wherein the object storage service for the user side is independent of object storage services for other user sides.

17. The electronic device according to claim 13, wherein the method is performed by a container service, and the obtaining the key from the key management service comprises:
sending a key obtaining request to the key management service, the key obtaining request comprising at least the key identification and attestation information of the container service, the attestation information indicating trustworthiness of the container service and an execution environment of the container service; and
receiving the key from the key management service, the key being sent by the key management service after verifying the container service.

18. An electronic device, comprising:
at least one processor; and
at least one memory, coupled to the at least one processor and storing instructions executable by the at least one processor, wherein the instructions, when executed by the at least one processor, cause the electronic device to perform the method according to claim 9.

19. A non-transitory computer-readable storage medium, having a computer program stored thereon, wherein the computer program is executable by at least one processor to implement the method according to claim 1.

20. A non-transitory computer-readable storage medium, having a computer program stored thereon, wherein the computer program is executable by at least one processor to implement the method according to claim 9.
